(19) United States
(12) Patent Application Publication
(10) Pub. No.: US 2009/0101151 A1
(43) Pub. Date: Apr. 23, 2009

(54) FILTER DEVICE FOR AIRBORNE PATHOGENS

(75) Inventor: Robert K. Russell, Grants Pass, OR (US)

Correspondence Address: BAUMGARTNER PATENT LAW, 5933 N.E. WIN SIVERS DR. SUITE 250, PORTLAND, OR, 97220, US

(73) Assignee: Clean Cough LLC, Grants Pass, OR (US)

(21) Appl. No.: 12/253,139

(22) Filed: Oct. 16, 2008

Related U.S. Application Data
(60) Provisional application No. 60/999,493, filed on Oct. 17, 2007.

(51) Int. Cl. A62B 18/08; B29C 39/00

(52) U.S. Cl. 128/206.17; 264/271.1

(57) ABSTRACT

This invention relates to a disposable handheld device that is put into the user's mouth, held by the teeth and sealed by the lips to stop or significantly reduce the spread of airborne pathogens from user coughing or sneezing. Preferred devices are recyclable, plastic, and are configured to be used with a filter infused with a germicide, bactericide, and/or a viricide. The devices provided herein can also protect the user by acting as a breathing filter that traps pathogens during inhalation and exhalation. Additionally, the devices herein are discrete and can be hidden in the hand of the user and placed in the mouth. Further preferred devices are hollow so it can be easily inspected at airport security or border checkpoints. Preferred devices herein also include an external clip to allow the user to secure the device in a pocket or on a lanyard around the user's neck.

### CROSS-REFERENCE TO RELATED APPLICATIONS

This application claims priority to U.S. Provisional Application No. 60/999,493 filed Oct. 17, 2007, which is expressly incorporated by reference in its entirety.

### FIELD OF THE INVENTION

This invention generally relates to the field of public health is directed to reducing the spread of airborne pathogens from an infected person into the environment. More specifically, the invention provided herein includes small, discreet, handheld devices having means for trapping and killing released pathogens from the infected person and means for allowing a user to breathe non-contaminated air.

### BACKGROUND

The prior art includes devices that attempted to prevent contaminants from being released from an infected person into the surrounding environment. Examples of these devices can be found in U.S. Pat. No. 6,986,348 to Carter, U.S. Pat. No. 3,719,188 to Fisher, et al., Japanese Pat. No. JP20052000098 to Shimizu Takeshi, and Shimizu Mikiyo, International Application No. PCT/CA2006/000666 to Mark, U.S. Pub. App. US20050194010 to Sankot, and U.S. Pat. No. 5,253,641 to Coate, for example.

Unfortunately, there are many disadvantages to these prior designs. For example, many of the previous devices only include means for preventing the expulsion of pathogens into the environment and do not provide means for actually killing the pathogens to prevent exposure at a later time. Additionally, many of the prior art devices do not provide a discrete, personal breathing filter, whereby a user can inhale and exhale non-contaminated air. For example, Carter only discloses a 1-way valve and thus cannot be used as a breathing filter. Additionally, many of the prior art devices are not inconspicuous and may be embarrassing or awkward for a user to wear and/or use. A further problem of prior devices is that some are not designed to be quickly inspected at airport security stations, such as the devices provided by Fisher, et al.

### SUMMARY OF THE INVENTION

Preferred devices described herein are designed to prevent the spread of airborne pathogens and can include a housing having an internal space and two ends, wherein the first end comprises an opening configured for a user to place their mouth over and the second end is closed; a window on the housing positioned in between the first and second ends and that provides an opening between the internal space of the housing and the outside of the housing; and a filter that covers the window such that it prevents the passage of particles through the window.

Preferred filters used herein are gas permeable such that allows the user to inhale and exhale through the first end's opening. Additionally, it is preferred that the filter is treated with an anti-microbial substance that is safe for the user to breathe in, such as colloidal silver.

Preferably, the first end of the housing comprises an outer rim that is configured to be positioned behind the user's teeth to prevent dislodgement of the device from the user's mouth during a cough or sneeze. Additionally, it is preferred that the housing comprises a second window.

Advantageously, the housing can include an internal space that is configured to hold a filter. More specifically, it is preferred that the housing is configured such that when the first end is place into the user's mouth, the remaining housing can be hidden in a user's hand, or substantially so. Preferably the housing and/or the filter is made of plastic, such as polypropylene.

Additional embodiments are directed to a housing designed to be used with a filter to prevent the spread of airborne pathogens and comprising first and second ends, wherein the first end comprises an opening configured for a user to place their mouth over and the second end is closed; and a window on the housing positioned in between the first and second ends and that provides an opening between the inside of the housing and the outside of the housing and is configured to be covered by the filter.

Preferably the first end of the housing comprises an outer rim that is configured to be positioned behind the user's teeth to prevent dislodgement of the device from the user's mouth during a cough or sneeze. Additionally, the housing can include a second window that provides an opening between the inside of the housing and the outside of the housing and is configured to be covered by the filter.

It is further preferred that the housing comprises an internal space configured to receive the filter. Alternatively, the housing can be configured to be used with an external filter.

Additional embodiments are directed to making the devices and housings described herein. One preferred method of making a device for preventing the spread of airborne pathogen includes placing a filter into an inner core of a plastic mold in the shape a housing, wherein said housing comprises an internal space and two ends, wherein the first end includes an opening configured for a user to place their mouth over and the second end is closed, and wherein the housing further comprises a window positioned in between the first and second ends and that provides an opening between the internal space of the housing and the outside of the housing; and pouring plastic into said molding such that the housing seals to the outside of the filter such that said filter covers the window.

It is preferred that said filter is treated with an anti-microbial before being placed into the plastic mold. It is further preferred that said housing comprises an outer rim that is configured to be positioned behind the user's teeth to prevent dislodgement of the device from the user's mouth during a cough or sneeze. Preferred methods further include the housing comprising a second window positioned in between the first and second ends and that provides an opening between the internal space of the housing and the outside of the housing, and said filter covers said second window after the plastic is poured into the molding.

### BRIEF DESCRIPTION OF THE DRAWINGS

It will be appreciated that the drawings are not necessarily to scale, with emphasis instead being placed on illustrating the various aspects and features of embodiments of the invention, in which:

FIG. 1 provides a view looking into the mouth piece's rimmed opening.

FIG. 2 provides a side view of a preferred device with a filter installed.

FIG. 3 provides a perspective view of housing without a filter.

FIG. 4 provides a view of the mouth piece rim.

FIG. 5 provides a perspective view of a preferred device with an installed internal filter.

FIG. 6 provides a view of an unrolled filter.

### DETAILED DESCRIPTION OF THE ILLUSTRATED EMBODIMENTS

Embodiments of the present invention are described below. It is, however, expressly noted that the present invention is not limited to these embodiments, but rather the intention is that modifications that are apparent to the person skilled in the art and equivalents thereof are also included.

Preferred devices 100 provided herein include a small housing 106 that can be entirely or substantially hidden in a user's enclosed fist and are configured to receive an internal filter 112. Preferred lengths of the device 100 are between 7-11 cm, 8-10 cm, 9-10 cm, or most preferably 9.8 cm, or substantially so. Preferred housings 106 are made of plastic, such as polypropylene, and are in the general shape of a cylinder, or a tapered cylinder, although the devices can be made with any suitable material or configured into any suitable shape, including rectangular, or conical, for example.

Preferably the housing 106 includes a mouth piece 101 having an opening for the user to cough into or breathe through. The opening on the mouth piece 101 preferably has a circumference of between 8-12 cm, 9-10 cm, or more preferably 10 cm, or substantially so. Preferably, the mouth piece 101 is configured to be placed inside of a user's mouth and includes an outer flange, lip, or rim 102 located on the outside of the mouth piece 101 and positioned around the opening, or near the opening of the mouth piece 101. Preferably the outer rim 102 is configured to be placed behind a user's teeth such that a user can place his lips around the mouth piece 101 to create a seal. While holding the remaining housing 106 in his fist, the user can cough or sneeze into the mouth piece 101 such that the particles from the cough are propelled into the internal space 110 within the housing 106, and into the filter 112. While the device 100 can also be used hands free, most users will likely hide the device 100 in their fist, so it only looks like they are coughing in their hand. Advantageously, the outer rim 102 is positioned behind the user's teeth to prevent the device 100 from dislodging from the user's mouth with the force generated by the user's cough or sneeze. Preferably the outer rim 102 has a larger circumference than that of the mouth piece 101 and can be 1 cm larger, for example. Preferred circumferences of the outer rim 102 include between 9-13 cm, 10-11 cm, and most preferably 11 cm, or substantially so. According to other embodiments, the outer rim 102 does not need to traverse the entire circumference of the mouth piece 101 so long as it can be anchored behind the user's teeth to prevent dislodgement during a cough or sneeze.

Preferably, the housing 106 is entirely hollow with the exception of the filter 112. This configuration allows for easy inspection of the device 100 at security checkpoints for example. The main body of the housing 106 can advantageously include an open mouth piece 101 at a first proximal end, and a closed, second distal end 114, positioned at the opposite end of the housing 106 from the mouth piece 101. It is advantageous that the second distal end 114 is closed to prevent the escape of particles or contaminants from the housing 106. Preferably, the circumference of the housing 106 is tapered towards the closed end 114. Preferred circumferences of the closed end are smaller than the circumference of the mouth piece 101, by 2 cm, or so, for example. Preferred ranges of the circumference of the closed end 114 include between 8-10 cm, between 7-9 cm, and most preferably 8 cm. The internal space 110 within the housing 106 in between the mouth piece 101 and the closed end 114 is advantageously configured to receive a filter 112.

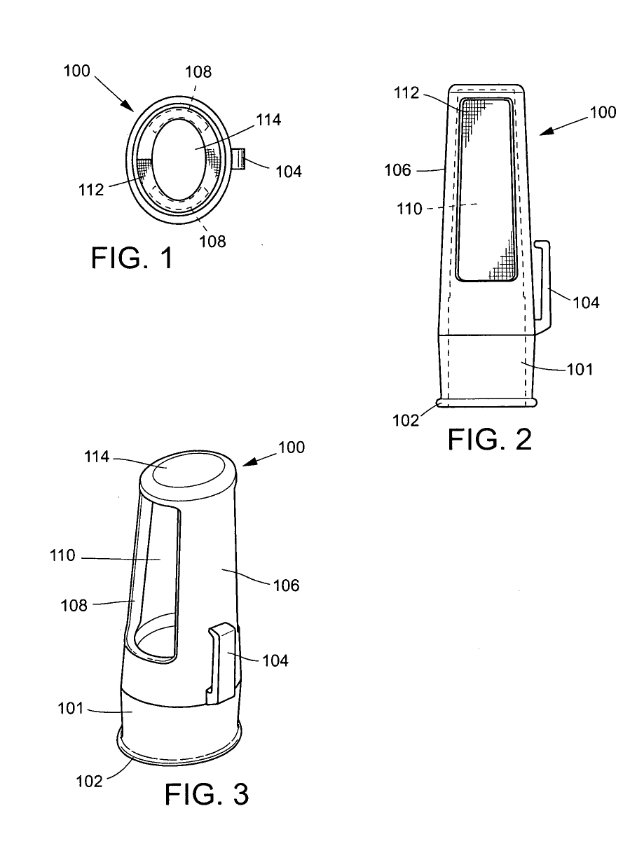

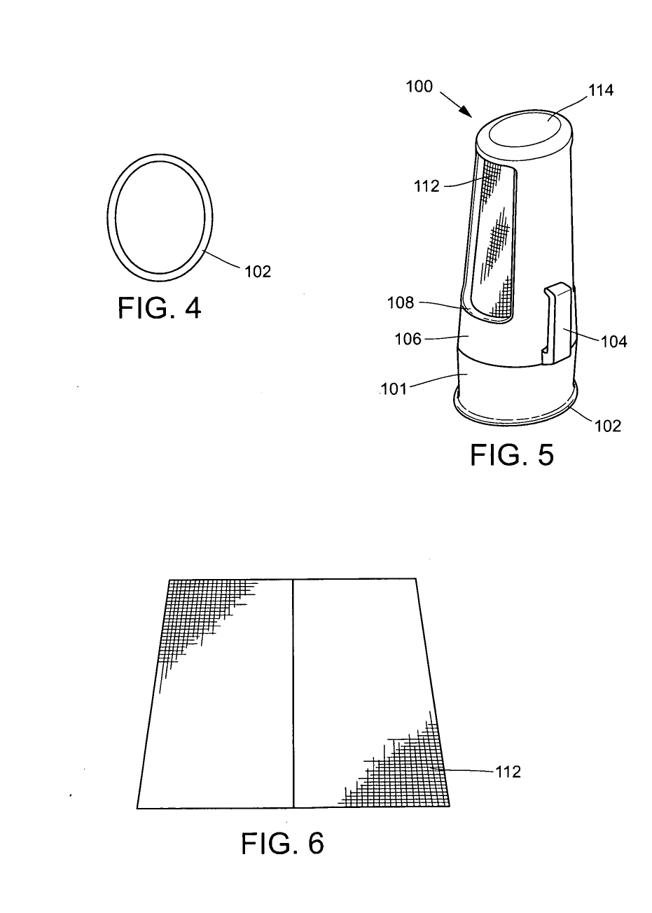

The sides of the housing 106 preferably include a first window 108 and a second window 105 that open into an internal hollow space 110 configured to receive a filter 112. Alternatively, the housing can include 1 or more windows, including 3, 4, 5, 6, for example. FIG. 3 depicts the preferred positioning of the first window 108. FIG. 2 depicts a window 108 covered by a filter 112. It is preferred that the second window 105 is the same size and shape as the first window 108 and is positioned on the opposite side of the housing 106 from the first window 108 as shown in FIG. 1. More specifically, the first window 108 and second window 105 can be advantageously positioned on the sides of the housing 106 such that they are aligned with one another. Preferred windows 108 and 105 taper towards the closed end 114. Windows 108 and 105 can be any suitable size to allow a user to breathe through but are preferably about 5.5 cm length wise, and have a height that tapers from 2.5 cm to 2 cm, or substantially so.

According to preferred embodiments, the filter 112 should be positioned within the housing 106 such that it covers both the first and the second windows 108 and 105. It is important to note that FIG. 3 does not depict the final or commercial embodiment of the device 100, rather it simply depicts the housing 106 without a filter 112 for explanatory purposes only.

Preferably the device 100 is made using injection molding. As shown in FIG. 6, the filter is cut out in the shape of a trapezoid, having only 1 set of parallel sides. The non-parallel lines taper towards the shorter side of the trapezoid. The preferred dimensions of the planar filter 112 are a top width of 9.7 cm and a bottom width of 7.9 with both tapered sides being 9 cm, or substantially so. The planar filter can then be treated with an anti-microbial and rolled into a tapered cylinder and sealed closed using an adhesive, or other suitable means.

The filter 112 can be treated with any suitable germicide, fungicide, bactericide, and/or a viricide for killing pathogens that is safe for a user to breathe in. One preferred anti-microbial that can be applied to a filter 112 is colloidal silver, for example. Preferably the colloidal silver is sprayed onto the filter 112 or otherwise applied so that the filter is impregnated with the anti-antimicrobial. Preferred filters 112 should be able to last about 7 days before they are ineffective.

Other sizes and shapes of planar filters can be used so long as they can be used to cover the windows 105 and 108 of the housing 106. For example, a quadrilateral, square, circular, triangular, elliptical, or rectangular shaped filter can be used and rolled up into a cylinder, tapered cylinder, cone, or other closed hollow shape, to fit within the filter space 110 within the housing 106. Preferably, the housing 106 is configured to enclose the rolled up filter 112 such that the tapered end fits near the closed end 104 and the filter 112 covers both windows 108 and 105.

After the filter 112 is ready for installation it is preferably placed in the inner core of a plastic mold in the shape of the housing 116. Plastic is then injected into the mold's cavity thus forming the completed device 100 which includes the housing 106 surrounding and sealed to the inner filter 112. Alternatively, the filter media can be affixed to the inside of the filter media compartment 110 or the outside of the filter media housing 106, by other means including a cartridge form, unrolled, or rolled up. For example a user could slide a filter over the outside of the windows 105 and 108, or place a new filter into the housing through a window 105 or 108 or the mouth piece opening. More specifically, according to alternative embodiments, the user can reuse the housing after a filter is too dirty to function properly and can install a new filter. Regardless of how or where the filter is affixed it is preferred that it seals, closes and/or covers the exhaust windows 108 and 105. Any suitable means of sealing, including the use of adhesives, for example, can be used.

According to preferred embodiments the filter 112 is made from plastic, such as polypropylene (woven or non-woven) such that the entire device 100 is recyclable, although it can be made of other suitable filtering materials, including paper, for example. Additionally, it is preferred that the filter 112 prevents the expulsion of particles and contaminants from the housing 106 outside the windows 108 and 105 and into the environment, but is gas permeable. More specifically, the filter 112 can be configured to allow the intake of oxygen through the windows 108 and 105 and into the housing 106. Likewise the filter 112 can allow the user's carbon dioxide to be expelled from the windows 108 and 105, so the user can breathe entirely through the mouth piece 101. According to this embodiment, the device can simultaneously protect the environment from the user's contaminants, and the user from contaminants in the environment. Alternatively, the device 100 can be used only as a breathing device or only as a means of protecting others from user generated contaminants.

Advantageous devices 100 further include an external clip 104 for fastening the device in a convenient location for the user to access such as on a piece of clothing or on a lanyard. The clip 104 can include any suitable spring mechanism such that it rests against the external side of the housing 106 in its natural state, but can be pulled away from the housing with a small, manual force from the user. Other fasteners including snaps, ties, hook and loop fasteners can also be attached to the housing 106.

The invention may be embodied in other specific forms besides and beyond those described herein. The foregoing embodiments are therefore to be considered in all respects illustrative rather than limiting, and the scope of the invention is defined and limited only by the appended claims and their equivalents, rather than by the foregoing description.

1. A device to prevent the spread of airborne pathogens comprising:
a housing having an internal space and two ends, wherein the first end comprises an opening configured for a user to place their mouth over and the second end is closed;
a window on the housing positioned in between the first and second ends and that provides an opening between the internal space of the housing and the outside of the housing; and
a filter that covers the window such that it prevents the passage of particles through the window.

2. The device of claim 1, wherein the filter is gas permeable such that allows the user to inhale and exhale through the first end's opening.

3. The device of claim 1, wherein said filter is treated with an anti-microbial substance that is safe for the user to breathe in.

4. The device of claim 3, wherein said anti-microbial is colloidal silver.

5. The device of claim 1, wherein the first end comprises an outer rim that is configured to be positioned behind the user's teeth to prevent dislodgement of the device from the user's mouth during a cough or sneeze.

6. The device of claim 1, wherein the housing comprises a second window.

7. The device of claim 1, wherein the internal space of the housing is configured to hold a filter.

8. The device of claim 1, wherein the housing is configured such that when the first end is place into the user's mouth, the remaining housing can be hidden in a user's hand, or substantially so.

9. The device of claim 1, wherein the housing is made of polypropylene

10. The device of claim 1, wherein the filter is made of polypropylene.

11. A housing designed to be used with a filter to prevent the spread of airborne pathogens comprising:
first and second ends, wherein the first end comprises an opening configured for a user to place their mouth over and the second end is closed; and
a window on the housing positioned in between the first and second ends and that provides an opening between the inside of the housing and the outside of the housing and is configured to be covered by the filter.

12. The housing of claim 11, wherein the first end comprises an outer rim that is configured to be positioned behind the user's teeth to prevent dislodgement of the device from the user's mouth during a cough or sneeze.

13. The housing of claim 11, wherein the housing comprises a second window that provides an opening between the inside of the housing and the outside of the housing and is configured to be covered by the filter.

14. The housing of claim 11, wherein the housing comprises an internal space configured to receive the filter.

15. The housing of claim 11, wherein the housing is configured to be used with an external filter.

16. A method of making a device for preventing the spread of airborne pathogens comprising:
placing a filter into an inner core of a plastic mold in the shape a housing, wherein said housing comprises an internal space and two ends, wherein the first end includes an opening configured for a user to place their mouth over and the second end is closed, and wherein the housing further comprises a window positioned in between the first and second ends and that provides an opening between the internal space of the housing and the outside of the housing;
pouring plastic into said molding such that the housing seals to the outside of the filter such that said filter covers the window.

17. The method of claim 16, wherein said filter is treated with an anti-microbial before being placed into the plastic mold.

18. The method of claim 16, wherein said housing comprises an outer rim that is configured to be positioned behind the user's teeth to prevent dislodgement of the device from the user's mouth during a cough or sneeze.

19. The method of claim 16, wherein the housing comprises a second window positioned in between the first and second ends and that provides an opening between the internal space of the housing and the outside of the housing, and said filter covers said second window after the plastic is poured into the molding.
